(19) United States
(12) Patent Application Publication
(10) Pub. No.: US 2008/0197735 A1
(43) Pub. Date: Aug. 21, 2008

(54) Rotor and stator fixture of electric motor

(75) Inventor: Chun-Ju Lin, Taipei County (TW)

Correspondence Address: BACON & THOMAS, PLLC, 625 SLATERS LANE, FOURTH FLOOR, ALEXANDRIA, VA, 22314, US

(73) Assignee: TEK-CHAIN TECHNOLOGY CO., LTD., Taoyuan City (TW)

(21) Appl. No.: 11/706,236

(22) Filed: Feb. 15, 2007

(51) Int. Cl. H02K 5/16

(52) U.S. Cl. 310/90

(57) ABSTRACT

The present invention discloses a stator and rotor fixture of an electric motor, and the fixture includes a frame, a stator and a rotor, both contained in the frame. The center of the stator installs a sheathing portion, and the sheathing portion has an embedding groove extended inwardly from an internal lateral side of an opening disposed at a free end of the sheathing portion, and a bearing sheathed into the sheathing portion. The center of the rotor installs an axle, and the axle is sheathed into the bearing, and the rotor has a latch extended outward and corresponding to the embedding groove, such that the corresponding embedding groove and latch fix the stator and the rotor securely together, so as to facilitate installing and removing an electric motor.

### BACKGROUND OF THE INVENTION

1. Field of the Invention

The present invention relates to a rotor and stator fixture of an electric motor, and more particularly to a rotor and stator fixture having an embedding groove extended inwardly from a sheathing portion of a rotor to be latched with a latch protruded outward from an internal lateral side of a rotor, so as to secure the stator and the rotor with each other and facilitate installing or removing the electric motor.

2. Description of the Related Art

Referring to FIG. 1 for a heat dissipating fan for a computer, the heat dissipating fan comprises a stator 100 and a rotor 200, wherein the stator 100 is comprised of a hollow circular bearing 101 disposed at a central position of the stator 100 and a magnetic pole 102 disposed at the periphery of the stator. An internal lateral side of the bearing 101 has an inwardly concave groove 103, and both corresponding ends of the groove 103 have two different sized openings. The rotor 200 comprises an axle 201, a permanent magnet 202 surrounding the internal periphery of the rotor 200, a lock ring 203 disposed at a free end of the axle 201 and a vane 204, and the diameter of the lock ring 203 falls between large and small openings in the groove 103.

In an installation, the rotor 200 is pivotally installed onto the stator 100, the axle 201 is passed into the bearing 101 of the stator 100, and a free end of the axle 201 is extended between the large and small openings of the groove 103, and a lock ring 203 is extended from the groove 103 to a latch at the axle 201, and the lock ring 203 presses against the smaller opening of the groove 103, so that the stator 100 and the rotor 200 can be fixed together. If the rotor 200 is rotated, the axle 201 will be driven to rotate in the bearing 101. Since a vane 204 of the rotor 200 produces turbulences as the vane 204 rotates. In the meantime, air flow also produces an outward pull reaction along the axial direction to the rotor 200. After a fan is assembled, its lock ring 203 is limited by the smaller opening of the groove 103, and thus the stator 100 and the rotor 200 will not be separated from each other easily during their operation. Regardless of the installation or the maintenance of the fan, the foregoing arrangement is very inconvenience, and increased manpower and manufacturing cost are incurred.

To overcome the shortcomings of installing and maintaining a fan with the foregoing structure, the present invention provides a rotor and stator fixture. In FIG. 2, a bearing 101 is made of an elastic hard plastic material, and a free end of the bearing 101 includes a tempered opening 104, an inwardly concave latch groove 2011 disposed on the axle 201, and the latch groove 2011 and the tampered opening 104 of the bearing 101 are latched with each other to fix the stator 100 and the rotor 200 together. Although this fixture can solve the aforementioned problems, the axle 201 will produce heat with a high temperature after being operated continuously, and the tampered opening 104 is in a direct contact with the latch groove 2011, and thus the high temperature causes an expansion, and the fixture cannot be latched to the latch groove 2011 effectively. As a result, the operation of the fan will be unstable, and the wearing-out and noise problems will arise.

### SUMMARY OF THE INVENTION

In view of the foregoing shortcomings of the prior art, the inventor of the present invention based on years of experience in the related field to conduct extensive researches and experiments, and finally developed a rotor and stator fixture of an electric motor in accordance with the present invention.

Therefore, it is a primary objective of the present invention to provide a rotor and stator fixture mainly applied for an electric motor for solving the inconvenient installation or removal of the stator and the rotor, as well as improving the convenience for maintaining the electric motor.

Another objective of the present invention is to install a stator and a rotor on the rotor and stator fixture, wherein the stator includes a sheathing portion, and the sheathing portion has an inwardly extended embedding groove at an internal lateral side of a free end of the opening, and a bearing is sheathed into the sheathing portion; wherein the rotor has an axle sheathed into the bearing, and a latch disposed at an internal lateral side of the rotor and corresponding to the embedding groove, so that the corresponding embedding groove and the latch can facilitate fixing the stator and the rotor with each other.

A further objective of the present invention is to build an open groove along an axial direction and disposed on the embedding groove, so that the open groove can provide an expanding and contracting resilience for the embedding groove.

Another further objective of the present invention is to solve the problems of producing heat with a high temperature by the high-speed operation of the axle, and causing the latch unable to be latched with the embedding groove due to the thermal expansion, provided that the stator and the rotor are fixed with each other.

### BRIEF DESCRIPTION OF THE DRAWINGS

FIG. 1 is a cross-sectional view of a prior art;

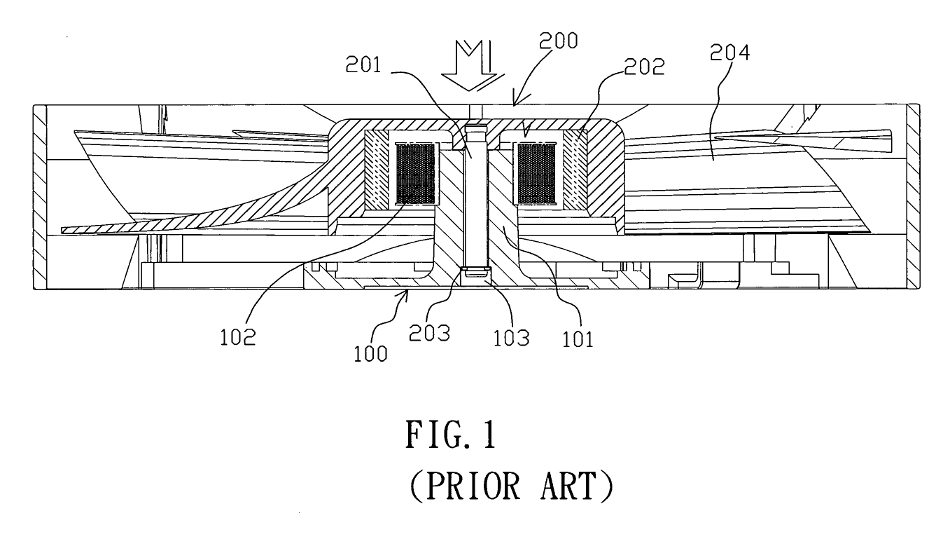

FIG. 2 is a cross-sectional view of another prior art;

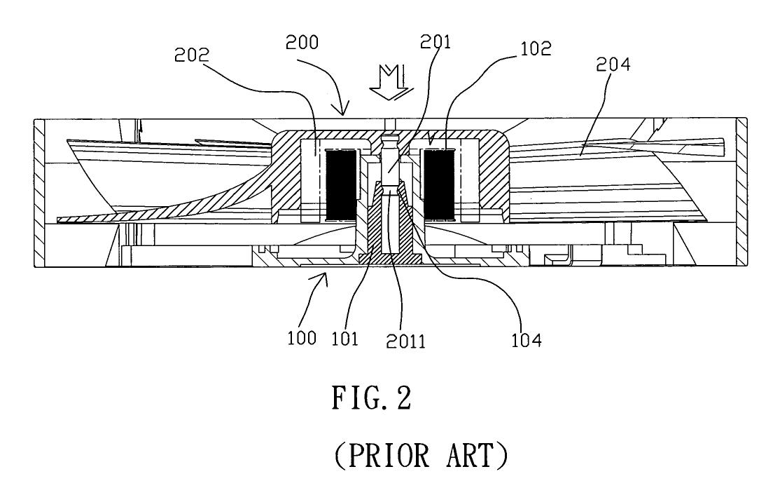

FIG. 3 is an exploded view of the present invention;

FIG. 4 is a cross-sectional view of the present invention;

FIG. 4A is an enlarged view of a sheathing portion coupled to an axle in accordance with the present invention;

FIG. 5 is a cross-sectional view of a preferred embodiment of the present invention; and

FIG. 6 is a cross-sectional view of another preferred embodiment of the present invention.

### DETAILED DESCRIPTION OF THE PREFERRED EMBODIMENTS

The above and other objects, features and advantages of the present invention will become apparent in the following detailed description of the preferred embodiments with reference to the accompanying drawing.

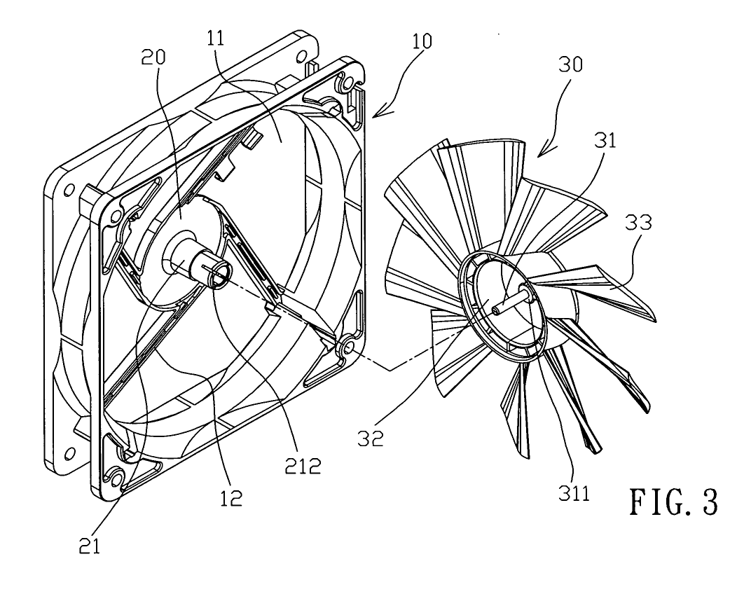

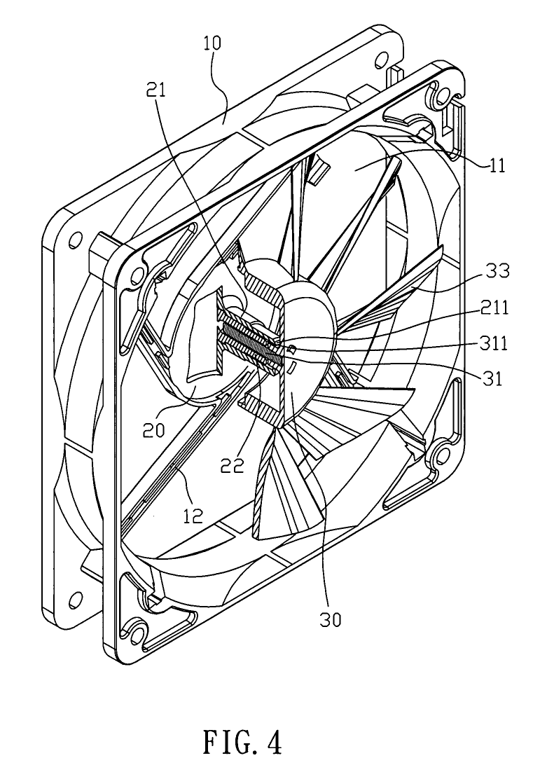

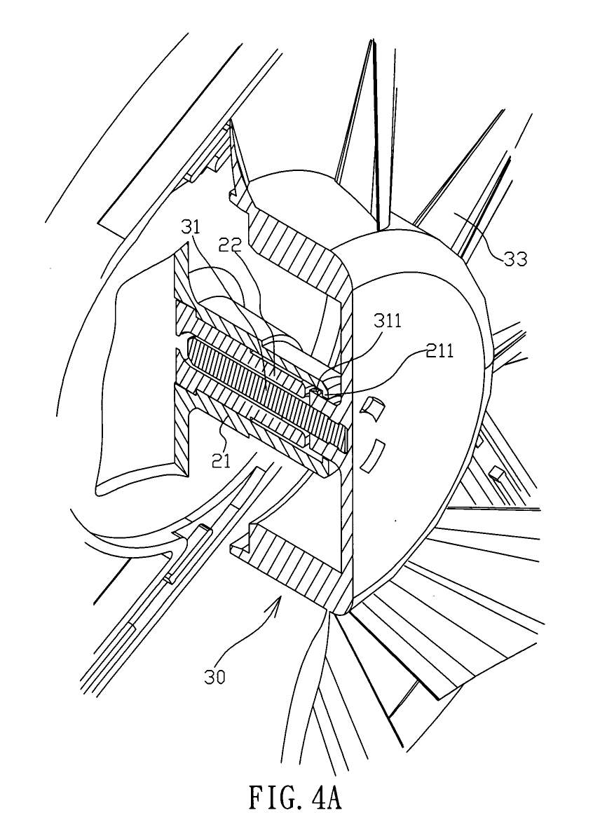

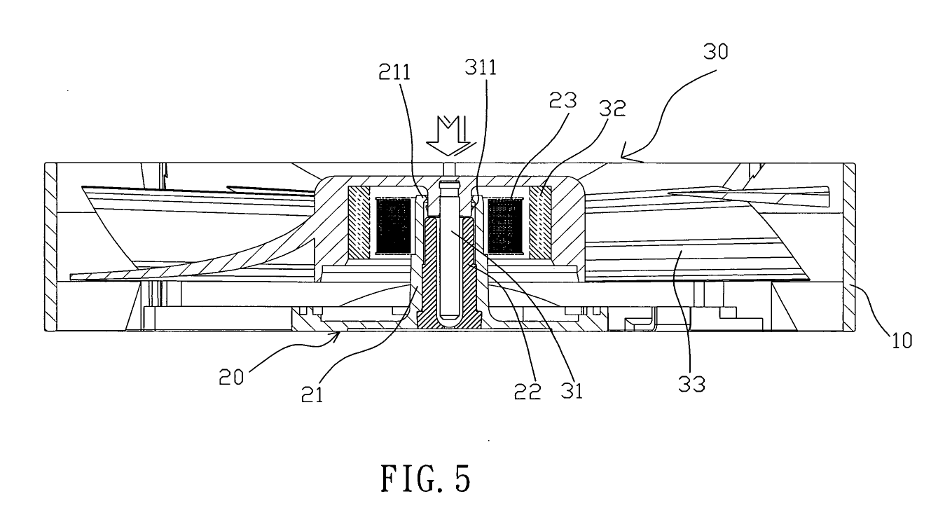

Referring to FIGS. 3, 4, 4A and 5 for a preferred embodiment of the present invention, the fixture comprises a frame 10, an opening 11 penetrating the frame 10, and a stator 20 and a rotor 30 contained in the frame 10. The stator 20 is installed at the middle of the opening 11, and the periphery of the stator 20 is coupled to the frame 10 by a rib 12, and the stator 20 has a sheathing portion 21 (which is made of a plastic material in this embodiment) disposed at the middle of the stator 2 and perpendicular to the stator 20, an embedding groove 211 (as shown in FIG. 4A) disposed at a free end of the internal lateral side of the sheathing portion 21, and an open groove 212 disposed along an axial direction of the embedding groove 211, such that open groove 212 provides a resilience for expansion and contraction for the embedding groove 211. Further, the sheathing portion 21 is sheathed by an internal hollow bearing 22 (which is also made of a plastic material in this embodiment), and the periphery of the sheathing portion 21 has a magnetic pole 23. The center of the rotor 30 comprises an axle 31, a permanent magnet 32 surrounding the internal periphery of the rotor 30, and a plurality of radial guide vanes 33 disposed at the external periphery of the rotor 30, and the axle 31 is sheathed into the bearing 22. Further, the internal lateral side of the rotor 30 includes a protruding latch 311, and the latch 311 can be embedded into the embedding groove 211(as shown in FIGS. 4 and 5) by the expanding and contracting actions of the embedding groove 211.

Referring to FIGS. 3, 4, 4A and 5 for the installation of the rotor and stator fixture of the invention, the axle 31 is sheathed into the bearing 21, such that the latch 311 can be embedded into the embedding groove 211 successfully by the open groove 212 of the embedding groove 211 with the expanding and contracting actions, such that the stator 20 and the rotor 30 can be fixed with each other.

During the removal of the rotor and stator fixture of the invention, the stator 20 is fixed, and a force is applied to the rotor 30, such that the latch 311 can be detached from the embedding groove 211 successfully by the open groove 212 on the embedding groove 211 with the expanding and contracting actions, so that the stator 20 and the rotor 30 can be separated to facilitate the installation and removal of a fan.

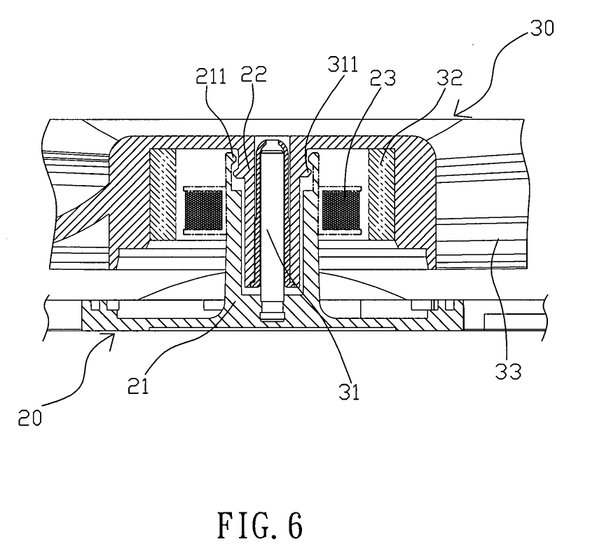

Referring to FIG. 6 for another preferred embodiment of the present invention, the major different of this embodiment from the aforementioned embodiment resides on that the axle 3 is fixed into the sheathing portion 21 of the stator 20, and an internal lateral side of a free end the sheathing portion 21 has an inwardly extended embedding groove 211, and the embedding groove 211 has an open groove 212 (not shown in the figure) disposed along the axial direction, and the open groove 212 is used for providing an expanding and contracting resilience for the embedding groove 211; and the middle of the rotor 30 has an internal hollow bearing 22, and the bearing 22 is sheathed concurrently into the sheathing portion 21 and axle 31, and the internal lateral side of the rotor 30 has a protruding latch 311, and the latch 311 can be embedded into the embedding groove 211 by the expanding and contracting actions of the embedding groove 211.

In summation of the description above, the present invention can enhance the installation and removal of an electric motor and overcome the shortcomings of the prior art, and the technical characteristics of the invention also enhances the performance of the conventional structure and further complies with the patent application requirements and is duly filed for a patent application.

Only some embodiments of the present invention have been illustrated in the drawings, but it should be pointed out that many other modifications are conceivable within the scope of the following claims.

What is claimed is:

1. A stator and rotor fixture of an electric motor, consisted of a frame, a stator and a rotor, both disposed in said frame, and said fixture comprising:
a sheathing portion, disposed at the center of said stator, and having an embedding groove extended inward from a free end disposed away from a connecting position of said sheathing portion;
a bearing, installed in said sheathing portion, and said bearing being an internal hollow ring;
an axle, installed at an internal side of said rotor, and sheathed into said bearing;
a latch, installed at an internal side of said rotor, and extended outward and corresponding to said embedding groove, for fixing said stator and said rotor securely with each other;
thereby, said corresponding embedding groove and latch facilitate fixing said stator and said rotor with each other.

2. The stator and rotor fixture of an electric motor of claim 1, wherein said embedding groove includes an axial open groove, such that said embedding groove has an expandable and contractible elasticity.

3. The stator and rotor fixture of an electric motor of claim 1, wherein said sheathing portion and said bearing are made of a plastic material.

4. The stator and rotor fixture of an electric motor of claim 1, wherein said stator and rotor fixture is installed in a heat dissipating fan of a computer.

5. A stator and rotor fixture of an electric motor, consisted of a frame, a stator and a rotor, both being disposed in said frame, and said fixture comprising:
a sheathing portion, disposed at the center of said stator, and having an embedding groove extended inward from a free end disposed away from a connecting position of said sheathing portion;
a bearing, fixed at the center of said rotor, and sheathed into said sheathing portion, and said bearing being an internal hollow ring, and said ring has a latch protruded outward from an external periphery of said ring, and corresponding to said bearing;
an axle, installed on said sheathing portion, and sheathed into said bearing;
a latch, installed at an internal side of said rotor, and extended outward and corresponding to said embedding groove, for fixing said stator and said rotor securely with each other;
thereby, said corresponding embedding groove and latch facilitate fixing said stator and said rotor securely with each other.

6. The stator and rotor fixture of an electric motor of claim 5, wherein said embedding groove includes an axial open groove, such that said embedding groove has an expandable and contractible elasticity.

7. The stator and rotor fixture of an electric motor of claim 5, wherein said sheathing portion and said bearing are made of a plastic material.

8. The stator and rotor fixture of an electric motor of claim 5, wherein said fixture is installed in a heat dissipating fan for a computer.
